(19) United States
(12) Patent Application Publication
(10) Pub. No.: US 2021/0178715 A1
(43) Pub. Date: Jun. 17, 2021

(54) FORMING DEVICE AND FORMING METHOD FOR GREEN TIRE

(71) Applicant: TOYO TIRE CORPORATION, Itami-shi (JP)

(72) Inventor: Hiroshi Nashio, Itami-shi (JP)

(73) Assignee: TOYO TIRE CORPORATION, Itami-shi (JP)

(21) Appl. No.: 17/114,889

(22) Filed: Dec. 8, 2020

(30) Foreign Application Priority Data
Dec. 13, 2019 (JP) 2019-225703

(51) Int. Cl. B29D 30/30

(52) U.S. Cl. CPC B29D 30/3007

(57) ABSTRACT

A forming device for a green tire includes a supply unit that supplies a strip-shaped ply sheet for forming a discontinuous carcass ply, a dividing portion that divides, in front in a feed direction of the ply sheet, the ply sheet supplied from the supply unit into two in a direction orthogonal to the feed direction, a guide portion that guides the ply piece sheets divided into two by the dividing portion so that the ply sheets are separated from each other in a direction orthogonal to the feed direction, a cutting portion that cuts the ply piece sheets divided into two by the dividing portion in the feed direction to separate the pair of ply pieces from the ply sheet, and a forming drum that winds up the pair of ply pieces.

### CROSS-REFERENCE TO RELATED APPLICATIONS

This application claims the benefit of priority of Japanese Patent Application No. 2019-225703 filed on Dec. 13, 2019, the contents of which are incorporated herein by reference in its entirety.

### BACKGROUND OF THE INVENTION

### Technical Field

The present invention relates to a forming device and a forming method for a green tire.

### Related Art

A carcass ply of a pneumatic tire disclosed in JP 2017-109517 A includes a first ply that is continuous between a pair of bead portions and a discontinuous second ply that is disposed on the outer side in the tire radial direction of the first ply. The second ply includes a pair of ply pieces extending from a tread portion to a pair of the bead portions, respectively. In the center of the tread portion, a region where neither of the two ply pieces exists, that is, a hollow portion is provided.

### SUMMARY OF THE INVENTION

The pneumatic tire of JP 2017-109517 A is manufactured by vulcanizing a green tire including a discontinuous carcass ply having a pair of ply pieces. However, JP 2017-109517 A does not disclose a forming device and a forming method for efficiently forming such a green tire.

An object of the present invention is to provide a green tire forming device and a forming method capable of efficiently forming a green tire including a discontinuous carcass ply having a pair of ply pieces.

One aspect of the present invention provides a forming device for a green tire including a discontinuous carcass ply having a pair of ply pieces. The forming device includes a supply unit that supplies a strip-shaped ply sheet for forming the discontinuous carcass ply, a dividing portion that divides, in front in a feed direction of the ply sheet, the ply sheet supplied from the supply unit into two in a direction orthogonal to the feed direction, a guide portion that guides the ply sheets divided into two by the dividing portion so that the ply sheets are separated from each other in a direction orthogonal to the feed direction, a cutting portion that cuts the ply sheets divided into two by the dividing portion in the feed direction to separate the pair of ply pieces from the ply sheets, and a forming drum that winds up the pair of ply pieces that are separated by the cutting portion and are separated from each other in a direction orthogonal to the feed direction.

If a pair of ply pieces are wound around a forming drum by using one supply unit that supplies one ply piece, it is necessary to wind one of a pair of ply pieces and the other around the forming drum in order, and a green tire cannot be manufactured efficiently. In contrast, according to the present configuration, a ply sheet supplied from one supply unit is divided and cut, so that a pair of ply pieces can be wound around the forming drum at once, and a green tire can be efficiently manufactured.

Further, if a pair of ply pieces are wound around a forming drum at once by using two supply units, each of which supplying one ply piece, it is necessary to prepare a ply piece for each of the two supply units, and a green tire cannot be manufactured efficiently. In contrast, according to the present configuration, a ply sheet supplied from one supply unit is divided and cut, so that a pair of ply pieces are supplied to the forming drum at once. Accordingly, as long as a ply sheet is prepared in one supply unit, it is not necessary to prepare each of a pair of ply pieces separately. In this manner, a green tire can be efficiently manufactured.

Further, since a pair of ply pieces are formed by dividing and cutting one ply sheet, uniformity of a pair of the ply pieces can be improved as compared with the case where a pair of ply pieces are manufactured separately.

Another aspect of the present invention provides a forming method for a green tire including a discontinuous carcass ply having a pair of ply pieces. The forming method includes supplying a ply sheet for forming the carcass ply, dividing the ply sheet into two in a direction orthogonal to a feed direction, feeding the ply sheets divided into two to front in the feed direction so that the ply sheets divided into two are gradually separated in a direction orthogonal to the feed direction, cutting the ply sheets divided into two in the feed direction to separate the pair of ply pieces from the ply sheet, and winding, around a forming drum, the pair of ply pieces.

According to the present invention, a green tire including a discontinuous carcass ply having a pair of ply pieces can be efficiently formed.

### BRIEF DESCRIPTION OF THE DRAWINGS

The foregoing and other features of the present invention will be apparent from the following description and the drawings of exemplary embodiments of the present invention. In the drawings, where:

FIG. 1 is a meridian cross-sectional view of a green tire according to an embodiment of the present invention;

FIG. 2 is a cross-sectional view of a tread portion of the green tire and its periphery according to the embodiment;

FIG. 3 is a perspective view showing a schematic configuration of a forming device for the green tire according to the embodiment;

FIG. 4 is a side view of a second forming unit of the forming device of FIG. 3;

FIG. 5 is a perspective view similar to FIG. 3 showing a schematic configuration of a forming device for a green tire according to a first comparative example; and

FIG. 6 is a perspective view similar to FIG. 3 showing a schematic configuration of a forming device for a green tire according to a second comparative example.

### DETAILED DESCRIPTION OF EMBODIMENTS

Hereinafter, an embodiment of the present invention will be described with reference to the drawings.

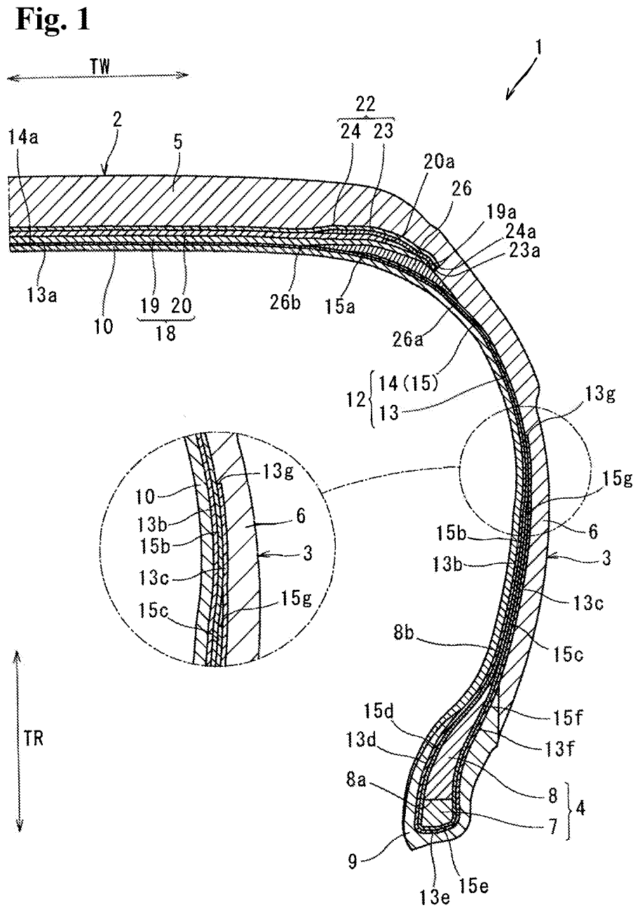

FIG. 1 is a meridian cross-sectional view of a green tire 1 according to the present embodiment. By vulcanizing the green tire 1 with a vulcanization device (not shown), a pneumatic tire made from rubber is manufactured.

As shown in FIG. 1, the green tire 1 includes a tread portion 2, a pair of sidewall portions 3, and a pair of ring-shaped bead portions 4.

The tread portion 2 includes tread rubber 5 extending in a tire width direction (indicated by the reference character TW in FIG. 1). The pneumatic tire manufactured by vulcanizing the green tire 1 is provided with a groove on the surface of the tread portion 2, that is, the tread surface.

Each of a pair of the sidewall portions 3 includes side rubber 6 extending from end of the tread portion 2 to the inner side in the tire radial direction (reference character TR in FIG. 1).

A pair of the bead portions 4 are disposed in end portions on the inner side in the tire radial direction of a pair of the sidewall portions 3. Each of the bead portions 4 includes a bead core 7 and a bead filler 8. The bead core 7 includes a large number of steel wires bundled in a ring shape. The bead filler 8 has a ring shape and is made from rubber that is harder than rubber that constitutes the tread portion 2 and the sidewall portion 3. The bead filler 8 includes a base end 8a disposed adjacent to the outer side in the tire radial direction of the bead core 7 and a tip end 8b on the side opposite to the base end 8a, and extends in a tapered shape to the outer side in the tire radial direction from the base end 8a toward the tip end 8b. Each of the bead portions 4 includes strip rubber 9 provided to wrap the bead core 7 and the bead filler 8.

The green tire 1 includes a carcass 12 hung in a toroidal shape between the bead portions 4. In the present embodiment, the carcass 12 includes a first carcass ply (hereinafter, referred to as “first ply”) 13 and a second carcass ply (hereinafter, referred to as “second ply”) 14. The second ply 14 is a ply having a hollow portion 14a, while the first ply 13 is a normal ply having no hollow portion. The first ply 13 and the second ply 14 will be described in detail later. An inner liner 10 is provided on the inner side of the carcass 12, that is, on the innermost peripheral surface of the green tire 1.

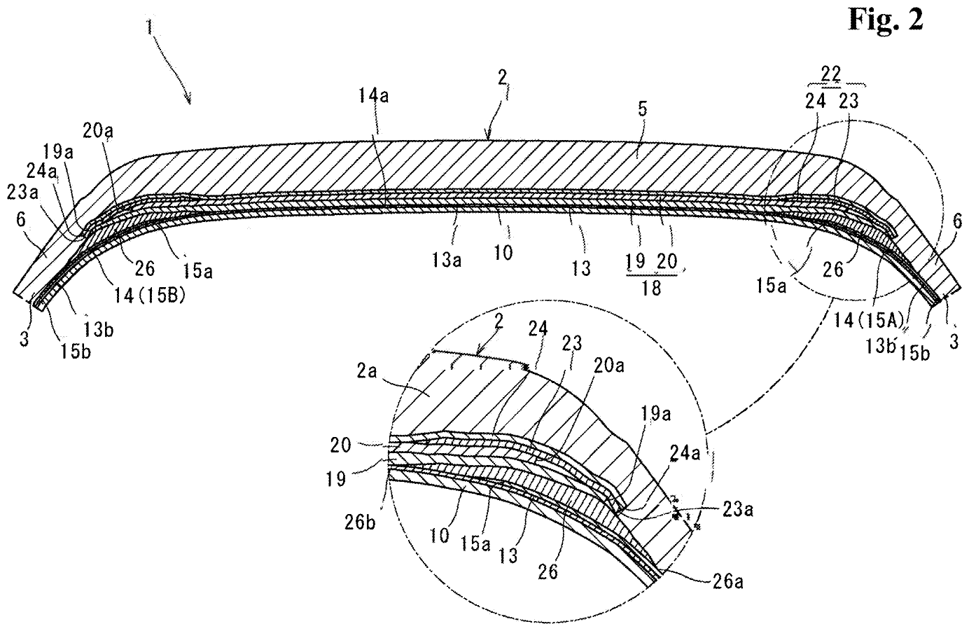

FIG. 2 is a cross-sectional view of the tread portion 2 of the green tire 1 and its periphery according to the present embodiment.

Referring to FIG. 2, an endless belt layer 18 is provided between the tread rubber 5 and the carcass 12 (first ply 13 and second ply 14). In the present embodiment, the belt layer 18 includes two belts 19 and 20. The belt 19 is disposed adjacent to the outer side in the tire radial direction of the carcass 12, and the belt 20 is disposed adjacent to the outer side in the tire radial direction of the belt 19. Further, in the present embodiment, the dimension in the tire width direction of the belt 19 in the lower layer is larger than the dimension in the tire width direction of the belt 20 in the upper layer, and an end portion 19a of the belt 19 is positioned on the outer side in the tire width direction of an end portion 20a of the belt 20. The belt layer 18 may be composed of one belt, or may include three or more belts.

An endless cap layer 22 is provided adjacent to the outer side in the tire radial direction of the belt layer 18. The cap layer 22 of the present embodiment includes a pair of narrow edge plies 23 that directly cover either of the end portions 19a and 20a of the belts 19 and 20. Further, the cap layer 22 of the present embodiment is disposed adjacent to the outer side in the tire radial direction of the edge ply 23, and includes a wide cap ply 24 as a single sheet that covers the entire belts 19 and 20 including the end portions 19a and 20a. The cap layer 22 may include one or three or more plies. Further, the cap layer 22 may be eliminated.

A pair of endless pads 26 made from rubber are disposed between both outer ends in the tire width direction of the belt layer 18 and the carcass 12. The cross-sectional shape of the pad 26 is a flat triangular shape. The positions in the tire width direction of the end portions 19a and 20a of the belts 19 and 20, the outer end portion 23a in the tire width direction of the edge ply 23, and an end portion 24a of the cap ply 24 are set in a region between an outer end portion 26a and an inner end portion 26b in the tire width direction of the pad 26, that is, a region where the pad 26 exists. The pad 26 may be eliminated.

Hereinafter, the first ply 13 and the second ply 14 constituting the carcass 12 will be described.

Referring to FIGS. 1 and 2, the first ply 13 is a single ply, while the second ply 14 is a discontinuous carcass ply having the hollow portion 14a as described above. The second ply 14 is composed of a pair of ply pieces 15.

The first ply 13 includes a central portion 13a positioned on the inner side in the tire radial direction of the tread portion 2, and a pair of side portions 13b extending from both ends in the tire width direction of the central portion 13a to the inner side in the tire radial direction. Further, the first ply 13 is provided continuously with the side portion 13b, and includes a wind-up portion 13c wound up from the inner side to the outer side in the tire width direction with respect to the bead core 7.

The central portion 13a extends from one to the other of inner end portions 15a of each of a pair of the ply pieces 15. More specifically, the range between the centers in the tire width direction of a pair of the pads 26 is the central portion 13a.

The side portion 13b is disposed adjacent to the outer side in the tire width direction of the inner liner 10.

The wind-up portion 13c is terminated in the sidewall portion 3. More specifically, the wind-up portion 13c includes an inner portion 13d, a winding portion 13e, and an outer portion 13f.

The inner portion 13d is disposed on the inner side in the tire width direction of the bead portion 4 (that is, the bead core 7 and the bead filler 8) with the ply piece 15 interposed between the inner portion 13d and the bead portion 4.

The winding portion 13e is provided continuously with the inner portion 13d, and is wound around the bead core 7 with the ply piece 15 interposed between them.

The outer portion 13f is provided continuously with the winding portion 13e, and is disposed on the outer side in the tire width direction of the bead portion 4 with the ply piece 15 interposed between them. An end portion of the outer portion 13f constitutes an end portion 13g of the first ply 13. The end portion 13g is positioned on the outer side in the tire radial direction of the tip end 8b of the bead filler 8 and is positioned on the inner side in the tire radial direction of the tread portion 2.

The second ply 14 is disposed adjacent to the outer side in the tire radial direction of the first ply 13, and is a discontinuous ply composed of a pair of the ply pieces 15. The ply piece 15 has the inner end portion 15a disposed between the belt layer 18 and the central portion 13a of the first ply 13. The pad 26 is interposed between the inner end portion 15a and the belt layer 18. The position in the tire width direction of the inner end portion 15a of the ply piece 15 is set in the outer region in the tire width direction of the tread portion 2, more specifically, in the region on the inner side in the tire width direction of both the end portions 19a and 20a of the belts 19 and 20 constituting the belt layer 18. The hollow portion 14a is provided in the region at the center in the tire width direction of the tread portion 2, more specifically, in the region between the inner end portions 15a of a pair of the ply pieces 15. In the hollow portion 14a, the second ply 14 does not exist, and only the central portion 13a of the first ply 13 exists.

The ply piece 15 includes a side portion 15b extending to the inner side in the tire radial direction from the inner end portion 15a, and a wind-up portion 15c wound up from the inner side to the outer side in the tire width direction with respect to the bead core 7.

The side portion 15b is disposed adjacent to the outer side in the tire width direction of the side portion 13b of the first ply 13.

The wind-up portion 15c is provided continuously with the side portion 15b and is terminated in the sidewall portion 3. The wind-up portion 15c includes an inner portion 15d, a winding portion 15e, and an outer portion 15f.

The inner portion 15d is disposed on the inner side in the tire radial direction of the bead portion 4, more specifically, between the bead portion 4 and the inner portion 13d of the first ply 13.

The winding portion 15e is provided continuously with the inner portion 15d and is wound around the bead core 7. More specifically, the winding portion 15e is disposed between the bead core 7 and the winding portion 13e of the first ply 13.

The outer portion 15f is provided continuously with the winding portion 15e, and is disposed on the outer side in the tire radial direction of the bead portion 4. Of the outer portion 15f, a part positioned on the inner side in the tire radial direction is disposed so as to overlap the outer side in the tire radial direction of the bead portion 4, and the rest is disposed so as to overlap the outer side in the tire radial direction of the side portion 15b. An end portion of the outer portion 15f constitutes an outer end portion 15g of the ply piece 15. The outer end portion 15g is positioned on the outer side in the tire radial direction of the tip end 8b of the bead filler 8 and is positioned on the inner side in the tire radial direction of the tread portion 2, more specifically, on the inner side in the tire radial direction of the end portion 13g of the first ply 13.

The first ply 13, the ply piece 15 of the second ply 14, the belts 19 and 20, the edge ply 23, and the cap ply 24 are all composed of a strip-shaped sheet in which a plurality of cords arranged side by side at intervals are covered with rubber. Other components than these and the bead core 7, that is, the tread rubber 5, the side rubber 6, the bead filler 8, the strip rubber 9, the inner liner 10, and the pad 26 are made from a rubber member.

The green tire 1 configured as described above is formed as described below.

First, the inner liner 10, the strip rubber 9, the first ply 13, and a pair of the ply pieces 15 are laminated in this order to form a cylindrical carcass band. Subsequently, the carcass band is subjected to a step including bead setting and turn-up to form a cylindrical green case. Separately from the carcass band, the pad 26, the belts 19 and 20, the edge ply 23, the cap ply 24, and the tread rubber 5 are laminated in this order to form a cylindrical tread band. After that, the green case disposed in the tread band is bulged to the outer side in the radial direction, and the carcass band is assembled with an inner peripheral portion of the tread band.

That is, forming of the green tire 1 includes a first forming step for forming the carcass band, a second forming step for forming the green case, a third forming step for forming the tread band, and a fourth forming step for assembling the green case and the tread band. A forming facility for the green tire 1 includes forming devices corresponding to the first forming step through the fourth forming step.

(Forming Device for Green Tire)

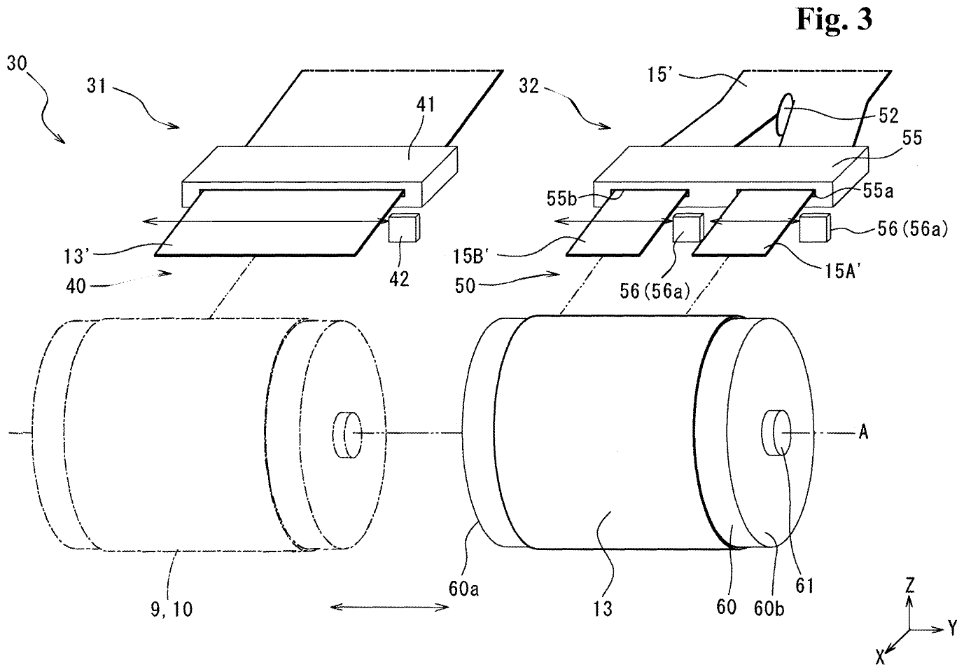

FIG. 3 shows a first forming device 30 that performs the first forming step. Specifically, FIG. 3 shows a ply forming unit of the forming device 30 for forming the first ply 13 and a pair of the ply pieces 15 (shown in FIG. 1). The other configurations of the first forming device 30, that is, the configuration of the forming unit for forming the inner liner 10 and the strip rubber 9 (shown in FIG. 1) is similar to the conventional one, and will be omitted from the detailed description. Similarly, the configurations other than the first forming device 30 are similar to those in the prior art, and will be omitted from the detailed description.

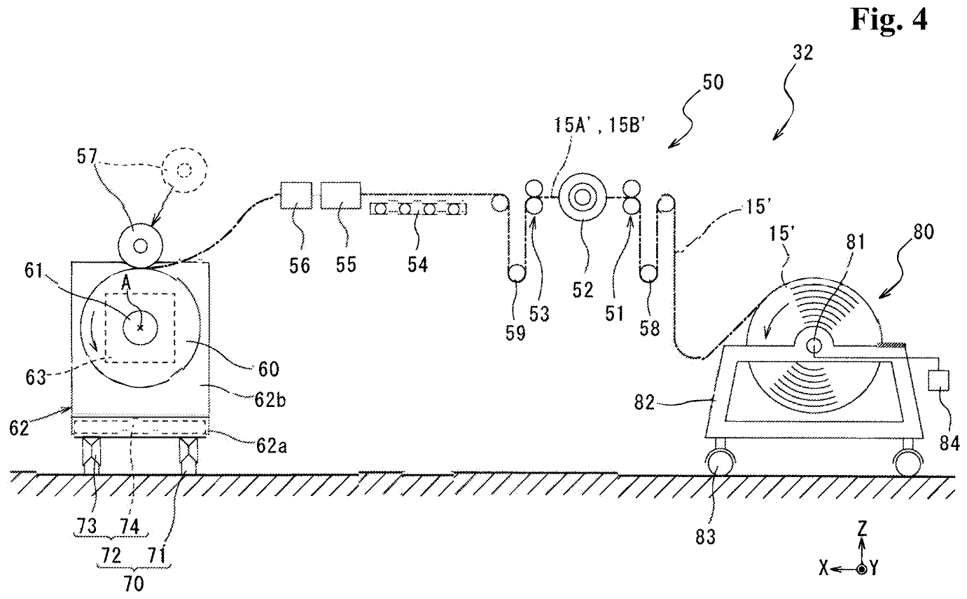

As shown in FIG. 3, the ply forming unit of the forming device 30 includes a first forming unit 31 for forming the first ply 13 (shown in FIG. 1) and a second forming unit 32 for forming the second ply 14 (shown in FIG. 1). Further, the ply forming unit of the forming device 30 includes one forming drum 60 and a moving mechanism 70 (shown in FIG. 4) for moving the forming drum 60. The forming drum 60 wound with the inner liner 10 and the strip rubber 9 is moved to the first forming unit 31 and the second forming unit 32 in this order, and the first ply 13 and the second ply 14 are sequentially formed on the outer circumference of the forming drum 60.

The first forming unit 31 and the second forming unit 32 are disposed adjacent to each other in the Y direction (axial direction) in which an axis A of the forming drum 60 extends.

The first forming unit 31 includes a first servicer 40 for sending out a strip-shaped first ply sheet 13′ for forming the first ply 13 (shown in FIG. 1) and a supply unit (not shown) for supplying the first ply sheet 13′ to the first servicer 40.

The first servicer 40 is disposed above the top of the forming drum 60, and supplies the first ply sheet 13′ to the forming drum 60 from above. The dimension (width) in the Y direction of the first ply sheet 13′ corresponds to the width of the first ply 13 from one of a pair of the end portions 13g (shown in FIG. 1) to the other.

The first servicer 40 includes a guide 41 for guiding the first ply sheet 13′ and a cutting portion 42 disposed between the guide 41 and the forming drum 60. The first ply sheet 13′ is supplied to the guide 41 of the first servicer 40 from the supply unit (not shown). The first ply sheet 13′ sent out toward the forming drum 60 by the guide 41 is cut to a predetermined length by the cutting portion 42, and the first ply 13 (shown in FIG. 1) is separated from the first ply sheet 13′.

The second forming unit 32 includes a second servicer 50 that sends out a strip-shaped second ply sheet 15′ for forming a pair of the ply pieces 15 (shown in FIG. 1). The second ply sheet 15′ of the present embodiment is an example of the ply sheet according to the present invention.

The second servicer 50 is disposed above the top of the forming drum 60, and supplies the second ply sheet 15′ divided into two to the forming drum 60 from above. In this manner, the second forming unit 32 forms both of a pair of the ply pieces 15 at the same time. In the description below, of a pair of the ply pieces 15, the one positioned on the right side in FIG. 2 may be referred to as a first ply piece 15A, and the one positioned on the left side in FIG. 2 may be referred to as a second ply piece 15B.

FIG. 4 is a side view of the second forming unit 32 of the forming device 30.

Referring to FIG. 4, the second forming unit 32 of the forming device 30 of the present embodiment includes an unwinding device 80 that supplies the second ply sheet 15′ to the second servicer 50. The unwinding device 80 according to the present embodiment is an example of the supply unit according to the present invention.

The unwinding device 80 includes a shaft portion 81 around which the second ply sheet 15′ is wound, a frame body 82 having a size surrounding the wound second ply sheet 15′, and a moving roller 83 attached to a lower part of the frame body 82. Further, the unwinding device 80 includes an electric motor 84, which is connected to the shaft portion 81 and rotationally drives the shaft portion 81. The shaft portion 81 is rotatably supported by the frame body 82. The shaft portion 81 is rotated counterclockwise in FIG. 4 by the electric motor 84, so that the second ply sheet 15′ is unwound toward the second servicer 50.

The second servicer 50 includes a pair of first conveyance rollers 51 that convey the second ply sheet 15′ supplied from the unwinding device 80 forward in the feed direction (X direction), a dividing portion 52, and two pairs of second conveyance rollers 53 (only one is shown in FIG. 4). Further, the second servicer 50 includes two conveyors 54 (only one is shown in FIG. 4), a guide 55, two cutting portions 56 (only one is shown in FIG. 4), and two holding rollers 57 (only one is shown in FIG. 4).

A pair of the first conveyance rollers 51 are rotated by an electric motor (not shown). Of a pair of the first conveyance rollers 51, the one positioned on the upper side rotates clockwise in FIG. 4, and the one positioned on the lower side rotates counterclockwise in FIG. 2. The second ply sheet 15′ is supplied from the unwinding device 80 to a pair of the first conveyance rollers 51. The first conveyance roller 51 conveys the second ply sheet 15′ supplied from the unwinding device 80 forward in the feed direction (X direction).

A first dancer roll 58 capable of linearly moving in the vertical direction (Z direction) is provided between the unwinding device 80 and a pair of the first conveyance rollers 51. The first dancer roll 58 absorbs a difference between a feed amount of the second ply sheet 15′ supplied from the unwinding device 80 and a feed amount of the second ply sheet 15′ fed forward in the feed direction by the first conveyance roller 51.

The dividing portion 52 is provided in front of the first conveyance roller 51 in the feed direction. The second ply sheet 15′ is supplied to the dividing portion 52 from the first conveyance roller 51. The dividing portion 52 divides the second ply sheet 15′ in two in a direction (Y direction) orthogonal to the feed direction. In this manner, the second ply sheet 15′ is divided into two in front of the dividing portion 52 in the feed direction. In the description below, one of the two divided second ply sheets 15′ may be referred to as a first ply piece sheet 15A′, and the other of the two divided second ply sheets 15′ may be referred to as the second ply piece sheet 15B′. The dividing portion 52 of the present embodiment is a round blade that is rotationally driven by an electric motor (not shown).

A pair of the second conveyance rollers 53 are provided in front of the dividing portion 52 in the feed direction. A pair of the second conveyance rollers 53 are rotated by an electric motor (not shown). Of a pair of the second conveyance rollers 53, the one positioned on the upper side rotates clockwise in FIG. 4, and the one positioned on the lower side rotates counterclockwise in FIG. 4. The first ply piece sheet 15A′ and the second ply piece sheet 158′ divided by the dividing portion 52 are supplied to two pairs of the second conveyance rollers 53, respectively. One of two pairs of the second conveyance rollers 53 conveys the first ply piece sheet 15A′ forward in the feed direction (X direction). The other of two pairs of the second conveyance rollers 53 conveys the second ply piece sheet 15B′ forward in the feed direction (X direction).

The two conveyors 54 are disposed between two pairs of the second conveyance rollers 53 and the forming drum 60. Each of the conveyors 54 is composed of a roller conveyor including a plurality of rollers disposed at intervals in the feed direction (X direction) of the second ply sheet 15′. The individual rollers extend in the width direction (Y direction) of the second ply sheet 15′. One of the two conveyors 54 conveys the first ply piece sheet 15A′ forward in the feed direction (X direction), and the other of the two conveyors 54 conveys the second ply piece sheet 15B′ forward in the feed direction (in the X direction).

Between a pair of the second conveyance rollers 53 and the conveyor 54, two second dancer rolls 59 capable of linearly moving in the vertical direction (Z direction) are provided. The first ply piece sheet 15A′ is hung on one of the two second dancer rolls 59, and the second ply piece sheet 158′ is hung on the other of the two second dancer rolls 59. One of the two second dancer rolls 59 absorbs a difference between a feed amount of the first ply piece sheet 15A′ fed forward in the feed direction by the second conveyance roller 53 and a feed amount of the first ply piece sheet 15A′ fed forward in the feed direction by the conveyor 54. The other of the two second dancer rolls 59 absorbs a difference between a feed amount of the second ply piece sheet 15B′ fed forward in the feed direction by the second conveyance roller 53 and a feed amount of the second ply piece sheet 15B′ fed forward in the feed direction by the conveyor 54.

The guide 55 is disposed between the two conveyors 54 and the forming drum 60. As most clearly shown in FIG. 3, the guide 55 is a square tubular frame body that determines the position for feeding the first ply piece sheet 15A′ and the second ply piece sheet 15B′. The guide 55 includes outlets 55a and 55b having a size by which the first ply piece sheet 15A′ and the second ply piece sheet 15B′ can be sent out. The outlets 55a and 55b are disposed apart from each other in a direction (Y direction) orthogonal to the feed direction (X direction). The guide 55 of the present embodiment is an example of the guide portion of the present invention.

The two cutting portions 56 are disposed between the guide 55 and the forming drum 60. Referring to FIG. 3, each of the two cutting portions 56 includes a cutter 56a capable of advancing and retreating in the width direction (Y direction) of the first ply piece sheet 15A′ and the second ply piece sheet 15B′. The movement of each of the cutters 56a separates the first ply piece 15A (shown in FIG. 2) from the first ply piece sheet 15A′ and the second ply piece 15B (shown in FIG. 2) from the second ply piece sheet 15B′.

Referring to FIG. 4, the two holding rollers 57 are disposed between each of the cutting portions 56 and the forming drum 60. Each of the two holding rollers 57 is made from an elastic body such as sponge, and can be moved to an advance position in contact with the top of the forming drum 60 and a retracted position away from the forming drum 60 by an actuator (not shown).

The forming drum 60 is a cylindrical body that can be expanded and contracted around a rotating shaft 61. Referring to FIG. 3, the total length of the forming drum 60 from a base end 60a to a tip end 60b is larger than the width of the widest first ply sheet 13′ among the tire components wound around the forming drum 60.

Referring to FIG. 4, the forming drum 60 is rotatably attached to a support base 62. The support base 62 includes a base portion 62a extending along the XY plane and a support portion 62b rising from one end of the base portion 62a along the XZ plane. An electric motor 63 is disposed inside the support portion 62b. The rotating shaft 61 is rotated counterclockwise in FIG. 4 by the drive of the electric motor 63, so that the forming drum 60 is integrally rotated.

The moving mechanism 70 moves the forming drum 60 relative to the first servicer 40 used for the first ply sheet 13′, and moves the forming drum 60 relative to the second servicer 50 used for the second ply sheet 15′. In the present embodiment, the first servicer 40 of the first forming unit 31 and the second servicer 50 of the second forming unit 32 are fixed at fixed positions, and the moving mechanism 70 moves only the forming drum 60 in the axial direction (Y direction) of the forming drum 60.

The moving mechanism 70 includes a conveyance path 71 that is laid to extend in the Y direction in which the first forming unit 31 and the second forming unit 32 are adjacent to each other, and a drive unit 72 that moves the forming drum 60 along the conveyance path 71. In the present embodiment, the conveyance path 71 is composed of a pair of rails that are adjacent to the first forming unit 31 (shown in FIG. 3) and the second forming unit 32 in the X direction and extend in parallel in the Y direction. The drive unit 72 includes four wheels 73 disposed at the bottom of the base portion 62a and an electric motor 74 disposed inside the base portion 62a. When the electric motor 74 rotates in the normal direction, the wheel 73 rotates in the normal direction, and the forming drum 60 moves to the right side in FIG. 3 integrally with the support base 62. When the electric motor 74 is reversed, the wheel 73 is reversed, and the forming drum 60 moves to the left side in FIG. 3 integrally with the support base 62.

The first forming unit 31, the second forming unit 32, the forming drum 60, the moving mechanism 70, and the unwinding device 80 are controlled by a control device (not shown). Specifically, the control device is electrically connected to an electric motor 84 of the unwinding device 90, electric motors (not shown) for driving the first conveyance roller 51, the dividing portion 52, and the second conveyance roller 53, the cutting portions 42 and 56, the holding roller 57, the electric motor 63 that rotates the forming drum 60, and the electric motor 74 of the moving mechanism 70 for moving the forming drum 60. The control device is composed of a well-known computer including a CPU, a memory, a storage device, and an input/output device, and software implemented in the computer.

(Forming of Second Ply)

In the present embodiment, the discontinuous second ply 14 is formed as a pair of the ply pieces 15 are wound at once around the forming drum 60 around which the inner liner 10, the strip rubber 9, and the first ply 13 are wound. Hereinafter, a forming method for the discontinuous second ply 14 of the present embodiment will be described.

Referring to FIGS. 3 and 4, first, the unwinding device 80, the first conveyance roller 51, the second conveyance roller 53, and the conveyor 54 are driven to convey the second ply sheet 15′ of the unwinding device 80 toward the forming drum 60. At this time, the second ply sheet 15′ is divided into two in front of the dividing portion 52 in the feed direction. Specifically, the second ply sheet 15′ is divided into the first ply piece sheet 15A′ and the second ply piece sheet 15B′ in front of the dividing portion 52 in the feed direction.

As is clearly shown in FIG. 3, the first ply piece sheet 15A′ and the second ply piece sheet 15B′ are sent so as to be gradually separated from each other toward the front in the feed direction in front of the dividing portion 52 in the feed direction.

At this time, by adjusting the feed amount of the second ply sheet 15′ of the first conveyance roller 51 and the feed amounts of the first ply piece sheet 15A′ and the second ply piece sheet 15B′ of the second conveyance roller 53, the second ply sheet 15′ can be maintained in a stretched state in the dividing portion 52. In this manner, the second ply sheet 15′ can be easily divided by the dividing portion 52.

Next, when the first ply piece sheet 15A′ and the second ply piece sheet 15B′ are sent out from the outlets 55a and 55b of the guide 55 and advance to the upper part of the forming drum 60 in a state of being separated from each other in the Y direction, the holding roller 57 at the retracted position is moved to an advanced position. In this manner, the tip ends of the first ply piece sheet 15A′ and the second ply piece sheet 15B′ are crimped to the forming drum 60 by the holding roller 57.

After that, by rotating the forming drum 60, the first ply piece sheet 15A′ and the second ply piece sheet 15B′ are wound around the outer peripheral surface of the forming drum 60.

Subsequently, when the forming drum 60 rotates to a predetermined angle position, the cutting portion 56 is driven to separate a pair of the ply pieces 15 (the first ply piece 15A and the second ply piece 15B) from the first ply piece sheet 15A′ and the second ply piece sheet 15B′. After that, the unwinding device 80, the first conveyance roller 51, the second conveyance roller 53, and the conveyor 54 are stopped. Further, when the cutting edges of the first ply piece sheet 15A′ and the second ply piece sheet 158′ pass through the holding roller 57, the holding roller 57 is moved to the retracted position and the rotation of the forming drum 60 is stopped.

### First Comparative Example

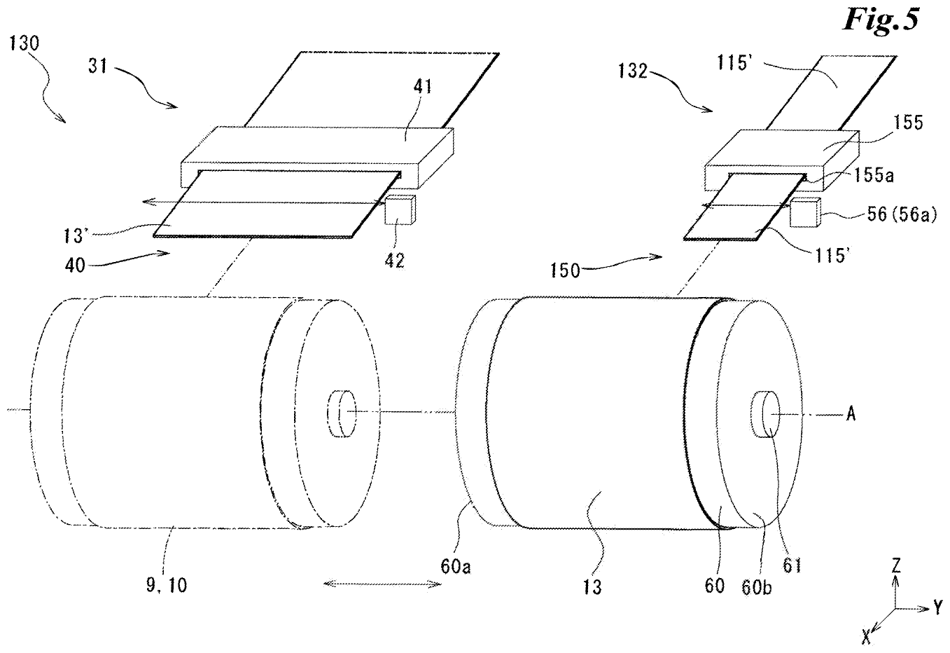

FIG. 5 is a schematic perspective view similar to FIG. 3 showing a schematic configuration of a ply forming unit of a forming device 130 according to a first comparative example. The forming device 130 according to the first comparative example has a configuration similar to that of the forming device 30 according to the embodiment of the present invention, except for a second forming unit 132. In the first comparative example, configurations similar to those of the embodiment of the present invention are designated by the same reference numerals, and omitted from detailed description.

Referring to FIG. 5, the second forming unit 132 according to the first comparative example includes one second servicer 150 that sends out a ply piece sheet 115′ for forming the ply piece 15. The second servicer 150 according to the first comparative example includes one guide 155 having one outlet 155a. The ply piece sheet 115′ is supplied to the guide 155 from one unwinding device (not shown). The ply piece sheet 115′ according to a first comparative example has a configuration similar to that of the ply piece sheets 15A′ and 15B′ according to the embodiment.

In the first comparative example, after forming the inner liner 10, the strip rubber 9, and the first ply 13, one of a pair of the ply pieces 15 and the other are formed in order.

Specifically, first, the ply piece sheet 115′ sent out from the guide 155 is wound around the forming drum 60 on which the first ply 13 is wound by the first forming unit 31, so that one of a pair of the ply pieces 15 is formed. After that, the forming drum 60 is moved in the Y direction, and the ply piece sheet 115′ sent out from the guide 155 is wound around the forming drum 60, so that the other of a pair of the ply pieces 15 is formed.

### Second Comparative Example

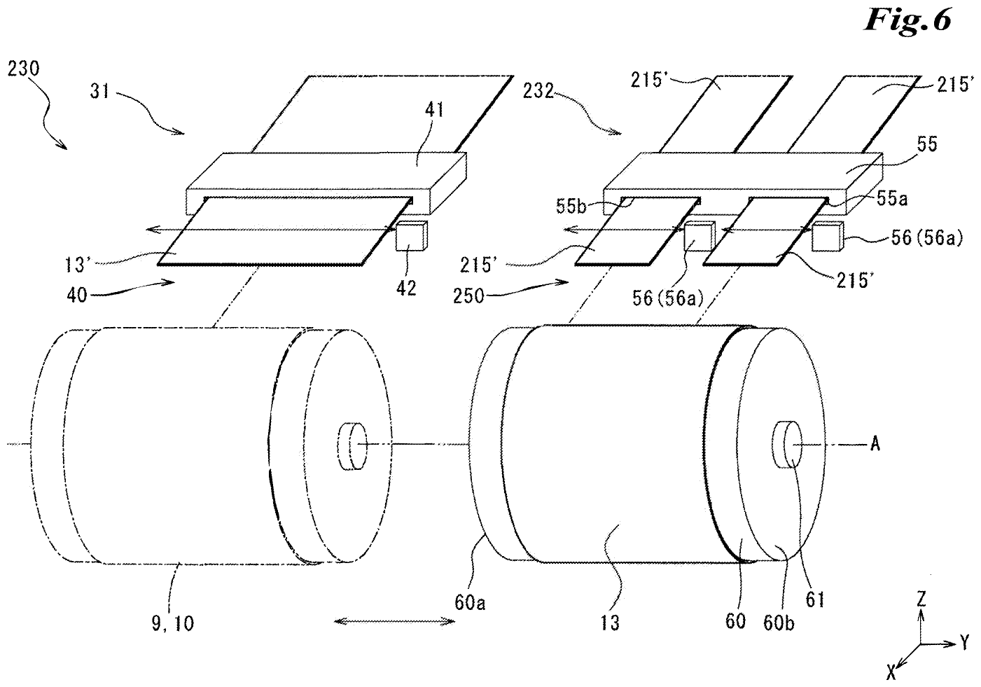

FIG. 6 is a schematic perspective view similar to FIG. 3 showing a schematic configuration of a ply forming unit of a forming device 230 according to a second comparative example. The forming device 230 according to the second comparative example has a configuration similar to that of the forming device 30 according to the embodiment of the present invention, except for a second forming unit 232. In the second comparative example, configurations similar to those of the embodiment of the present invention are designated by the same reference numerals, and omitted from detailed description.

Referring to FIG. 6, the second forming unit 232 according to the second comparative example includes two unwinding devices (not shown). In the second comparative example, the guide 55 of a second servicer 250 is supplied with a ply piece sheet 215′ from each of the two unwinding devices. In the second comparative example, the ply piece sheet 215′ supplied from one of the two unwinding devices is sent out from the outlet 55a of the guide 55, and the ply piece sheet 215′ supplied from the other of the two unwinding devices is sent out from the outlet 55b of the guide 55. The ply piece sheet 215′ according to a second comparative example has a configuration similar to that of the ply piece sheets 15A′ and 15B′ according to the embodiment.

In the second variation, a pair of the ply pieces 15 are formed at one time by the second forming unit 232 as in the embodiment of the present invention.

According to the forming device and the forming method for the green tire 1 of the present embodiment, an action and an effect described below are achieved.

If, as in the first comparative example, a pair of the ply pieces 15 are wound around the forming drum 60 by using the one second servicer 150 that sends out the one ply piece sheet 115′, it is necessary to wind one of a pair of the ply pieces 15 and the other around the forming drum 60 in order, and the green tire 1 cannot be manufactured efficiently. In contrast, according to the present embodiment, the ply sheet 15′ supplied from the unwinding device 80 is divided and cut by the second servicer 50, so that a pair of the ply piece sheets 15A′ and 15B′ for forming a pair of the ply pieces 15 can be sent out from the second servicer 50 at once. In this manner, a pair of the ply pieces 15 are formed by the forming drum 60 at once, so that the green tire 1 can be efficiently manufactured.

Further, if, as in the second comparative example, a pair of the ply pieces 15 are wound around the forming drum 60 at once by using two unwinding devices for supplying the one ply piece sheet 215′, it is necessary to prepare the ply piece sheet 215′ for each of the two unwinding devices, and the green tire 1 cannot be manufactured efficiently. In contrast, according to the present embodiment, the ply sheet 15′ supplied from the unwinding device 80 is divided and cut by the second servicer 50, so that a pair of the ply piece sheets 15A′ and 158′ for forming a pair of the ply pieces 15 can be sent out from the second servicer 50 at once. That is, as long as the ply sheet 15′ is prepared in the one unwinding device 80, it is not necessary to prepare the ply piece sheet 215′ in each of the two unwinding devices separately. In this manner, the green tire 1 can be efficiently manufactured.

Further, since a pair of the ply pieces 15 are formed by dividing and cutting the one ply sheet 15′, uniformity of a pair of the ply pieces 15 can be improved as compared with the case where a pair of the ply pieces 15 are manufactured separately.

Further, since the first conveyance roller 51 is provided in front of the dividing portion 52 in the feed direction and the second conveyance roller 53 is provided behind the dividing portion 52 in the feed direction, by adjusting the feed amount of the first conveyance roller 51 and the feed amount of the second conveyance roller 53, the tension of the second ply sheet 15′ at the dividing portion 52 is adjusted. That is, the second servicer 50 of the present embodiment has a tension control mechanism for adjusting the tension of the second ply sheet 15′ in the dividing portion 52. In this manner, the state in which the second ply sheet 15′ is stretched can be easily maintained in the dividing portion 52, and the second ply sheet 15′ can be easily divided by the dividing portion 52.

Further, according to the forming method for the green tire 1 according to the present embodiment, the green tire 1 can be efficiently formed as described above.

For example, in the embodiment, the first forming unit 31 and the second forming unit 32 are disposed adjacent to each other in the Y direction. However, the present invention is not limited to this, and the first forming unit 31 and the second forming unit 32 may be disposed side by side in the Z direction (vertical direction).

For example, in the embodiment, the one guide 55 includes two outlets 55a and 55b. However, the present invention is not limited to this, and the two outlets 55a and 55b may be provided in separate guides.

For example, in the embodiment, the dividing portion 52 is a round blade that is rotationally driven by an electric motor. However, the present invention is not limited to this, and the dividing portion 52 may be, for example, a saw blade that can move linearly in the vertical direction.

What is claimed is:

1. A forming device for a green tire including a discontinuous carcass ply having a pair of ply pieces, the forming device comprising:
a supply unit that supplies a strip-shaped ply sheet for forming the discontinuous carcass ply;
a dividing portion that divides, in front in a feed direction of the ply sheet, the ply sheet supplied from the supply unit into two in a direction orthogonal to the feed direction;
a guide portion that guides the ply sheets divided into two by the dividing portion so that the ply sheets are separated from each other in a direction orthogonal to the feed direction;
a cutting portion that cuts the ply sheets divided into two by the dividing portion in the feed direction to separate the pair of ply pieces from the ply sheets; and
a forming drum that winds up the pair of ply pieces that are separated by the cutting portion and are separated from each other in a direction orthogonal to the feed direction.

2. A forming device for a green tire according to claim 1, the forming device comprising a tension control mechanism for adjusting the tension of the ply sheet provided behind the dividing portion in the feed direction.

3. A forming method for a green tire including a discontinuous carcass ply having a pair of ply pieces, the forming method comprising:
supplying a ply sheet for forming the carcass ply;
dividing the ply sheet into two in a direction orthogonal to a feed direction;
feeding the ply sheets divided into two to front in the feed direction so that the ply sheets divided into two are gradually separated in a direction orthogonal to the feed direction;
cutting the ply sheets divided into two in the feed direction to separate the pair of ply pieces from the ply sheet; and
winding, around a forming drum, the pair of ply pieces that are separated from each other in a direction orthogonal to the feed direction.

4. A forming method for a green tire according to claim 3 comprising adjusting the tension of the ply sheet before dividing the ply sheet into two.
